(19) United States
(12) Patent Application Publication
(10) Pub. No.: US 2005/0157694 A1
(43) Pub. Date: Jul. 21, 2005

(54) Time division duplex system and method with improved guard time

(75) Inventors: Ben Lu, Plainsboro, NJ (US); Richard D. Gitlin, Little Silver, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 10/762,162

(22) Filed: Jan. 21, 2004

(51) Int. Cl. H04J 3/00

(52) U.S. Cl. 370/345; 370/508

(57) ABSTRACT

A method and system are disclosed that improve the efficiency of a time division duplex communication system. The uplink transmission slots of a plurality of mobile stations are arranged in an order so as to take advantage of the short propagation delay to the closest mobile stations, thereby advantageously resulting in a time division duplex guard time which is potentially independent of cell size.

### BACKGROUND OF THE INVENTION

The invention relates to communication networks, and, more particularly, to wireless communication networks utilizing time division duplex techniques.

Time division duplex (TDD) and frequency division duplex (FDD) represent two different strategies for allocating the spectrum resource between a pair of stations for two-way communication. TDD is a well-known technique that divides a single communication channel into uplink and downlink time slots; this is in contrast to FDD which separate uplink and downlink communication into different frequencies/channels. Many existing cordless telephones utilize TDD-based techniques. Although cellular telephones today primarily rely on FDD techniques, many recent third generation (3G) and fourth generation (4G) wireless proposals introduce schemes based on time division duplex. See, e.g., G. J. R. Povey and Masao Nakagawa, “A Review of Time Division Duplex—CDMA Techniques,” Proceedings, 1998 IEEE 5^{th} International Symposium on Spread Spectrum Techniques and Applications, vol. 2, pp. 630-33, Sep. 2-4, 1998. TDD offers numerous potential advantages over FDD, including the ability to exploit the reciprocity/symmetry of the downlink and uplink radio frequency channels, which facilitates adaptive modulation, coding, spatial domain processing, and scheduling at the transmit side of a base station. In short, TDD can potentially make more efficient use of the wireless spectrum resource.

On the other hand, a drawback of conventional time division duplex is that it requires a guard time interval to separate the downlink and uplink time slots. Since the guard time reflects the round trip propagation delay to the farthest mobile station in a cell, the guard time must increase as cell size increases in order to take into account the longer propagation delays. In existing time division duplex systems, the guard time interval accounts for both inefficiency (since no information is transmitted within a guard time interval) and a restriction on maximum cell size. Moreover, the disadvantage may increase when the system further employs time-division multiple access (TDMA) technology, because the time resource has to be sliced between the uplink and downlink as well as among the multiple users.

Accordingly, there is a need for improvements in the efficiency of a time division duplex communication system.

In U.S. Pat. Nos. 5,959,980 and 6,388,997, the contents of which are incorporated by reference herein, a technique was disclosed which reduces the guard time based on an estimate of the actual propagation time between the base station and a particular mobile station. By measuring the distance between the base station and the mobile station, the base station can order the mobile station to decrease the guard time for the mobile station's time slots based on the estimated distance rather than the cell radius. This results in a guard time that is, on average, shorter than available with conventional time division duplex techniques.

### SUMMARY OF INVENTION

The present invention is directed to mechanisms that further improve the efficiency of a time division duplex communication system. In accordance with an aspect of the invention, the uplink transmission slots of a plurality of mobile stations are arranged in an order so as to take advantage of the short propagation delay to the closest mobile stations. Where the propagation delay between the base station and a first mobile station is less than the propagation delay between the base station and a second mobile station, the first mobile station is permitted to transmit in a time slot before the time slot of the second mobile station in the frame. The guard time between transmissions from the base station to the mobile stations and transmissions received by the base station from the mobile stations is set to a value based on the propagation delay between the base station and the first mobile station, which is preferably the closest mobile station. The time resource of the time division duplex frame is preferably divided into a downlink superframe and an uplink superframe, with a guard time interval there between. The uplink superframe begins with the uplink time slot of a mobile station close to the base station, with a corresponding smaller propagation delay to the base station, followed by the remaining mobile stations. The overall guard time, thereby, is only restricted by the propagation delay to the closest mobile station.

The present invention results in a time slot structure in a time division duplex communication system that has a higher efficiency than existing systems and, moreover, that results in a guard time design that is potentially independent of the cell size.

These and other advantages of the invention will be apparent to those of ordinary skill in the art by reference to the following detailed description and the accompanying drawings.

### SUMMARY OF DRAWINGS

FIG. 1 is a diagram of a base station and a plurality of mobile stations in a mobile communication network, used to illustrate aspects of the present invention.

FIG. 2 is a diagram of a time slot allocation, illustrating prior art techniques.

FIG. 3 is a flowchart of processing performed by a base station in accordance with an embodiment of the present invention.

FIG. 4 is a diagram of a time slot allocation, from the point of view of a base station and a plurality of mobile stations, in accordance with an embodiment of the present invention.

FIGS. 5 and 6 are simplified diagrams of the components of a base station and a mobile station, respectively, in accordance with an embodiment of the present invention.

### DETAILED DESCRIPTION

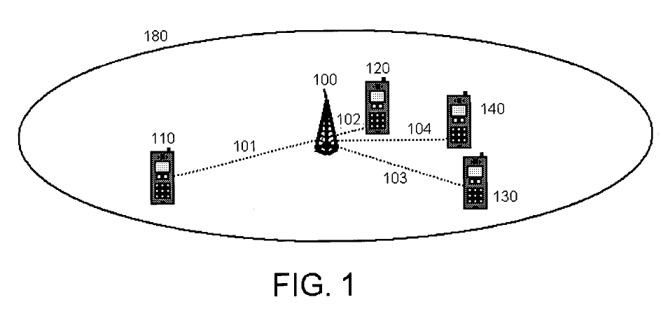

FIG. 1 is a diagram of a mobile communication network, illustrating aspects of an embodiment of the present invention. FIG. 1 depicts a single cell with one base station 100 and a plurality of mobile stations, 110, 120, 130, and 140. The mobile stations, for illustration purposes, are assumed to be at different distances from the base station 100. Mobile station 120 is depicted as closest to the base station 100, at a distance shown as 102. Mobile station 140 is the second closest, at a distance depicted as 104. Mobile stations 110 and 130 are the furthest from the base station 100, at approximately the same distance shown as 101 and 103 respectively. The cell radius of the base station 100 is depicted in FIG. 1 as 180.

The mobile stations 110, 120, 130, 140 and the base station 100 are assumed to have appropriate interfaces for establishing a wireless communication link. It should be noted that the present invention is not limited to any particular wireless link technology, although, as mentioned above, the present invention has particular relevance to next generation (3G/4G) wireless systems.

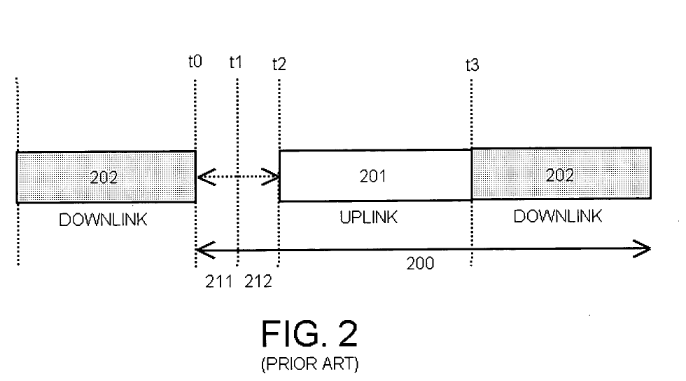

It is assumed that some form of time division duplex (TDD) is utilized to establish two-way communication between the base station 100 and the mobile stations 110, 120, 130, 140. The communication link from the base station to the mobile stations is referred to as downlink communication, while the link from a mobile station to the base station is referred to as an uplink. Uplink communication and downlink communication are allocated in separate time slots of a TDD frame, as depicted in FIG. 2. FIG. 2 shows an illustrative TDD frame 200 with an uplink time slot 201 and a downlink time slot 202. Neither the base stations nor the mobile stations are assumed to support duplex transmission, i.e., transmitting and receiving at the same time. Accordingly, it is presumed in TDD systems that collisions between downlink and uplink slots—and between uplink slots of different mobile stations—should be avoided. Collisions between downlink slots can be assumed to be unlikely, as the downlink slots can be sent sequentially by the same base station.

As depicted in FIG. 2, a guard time interval 205 is provided between the uplink time slot 201 and the downlink time slot 202. In a conventional TDD system, the guard time interval 205 would be fixed to accommodate the maximum possible round trip delay between an arbitrary mobile station and the base station (in addition to any delay inherent in switching between transmit and receive modes). Thus, the guard time is typically estimated as:

$$Guard Time = 2 \times \frac{Cell Radius}{Speed of Light}$$

This represents the round-trip propagation time (RTT) between the base station and a mobile station positioned at the edge of the cell (depicted as the time between t0 to t2 in FIG. 2)—or twice the single trip propagation time (STT) from the base station to the cell radius (depicted as the time between t0 and t1 or between t1 and t2 in FIG. 2). Thus, in a conventional TDD system, a fixed guard time is allocated in each time slot, regardless of how near or far a mobile station is within the cell, resulting in low efficiency—especially where the cell size is large. A preferable alternative is to measure the actual distance to a mobile station's location (e.g., by a ranging protocol) and advancing/delaying each mobile station's uplink transmission timing, as proposed in U.S. Pat. Nos. 5,959,980 and 6,388,997, the contents of which are hereby incorporated by reference herein. The proposed scheme results in a mobile station-dependent guard time that is approximately:

$$Guard Time = 2 \times \frac{Distance from MS to BS}{Speed of Light}$$

Since the distance from any mobile station to the base station is always less than the cell radius, the guard time interval would be on average shorter than in conventional TDD, thereby improving the efficiency of the system.

Nevertheless, the efficiency of the system can be further improved by allocating uplink transmissions from different mobile stations in a particular order. This advantageously results in a guard time interval that can be independent of cell size radius.

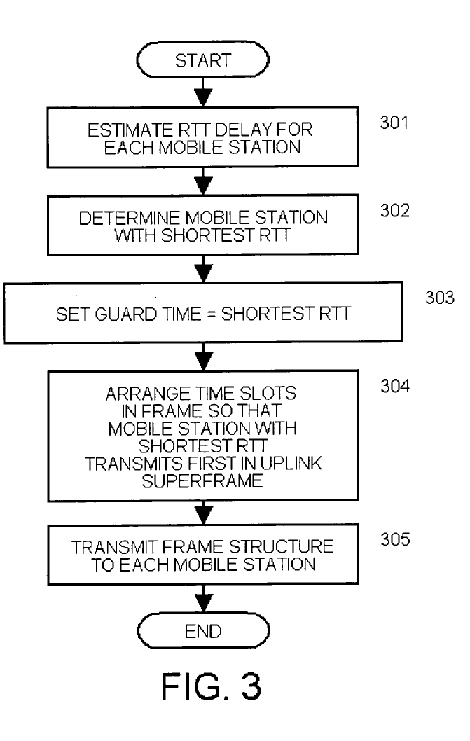

FIG. 3 is a flowchart of processing performed by a base station in accordance with an embodiment of this aspect of the present invention. At step 301, an estimate is made of the round trip propagation time between the base station and each mobile station in the cell. This can be readily accomplished using any of a number of known techniques, including ranging protocols or even through the use of integrated positioning mechanisms such as GPS. At step 302, the mobile station with the shortest propagation time is determined. Then, at step 303, the guard time interval for the TDD frame is set to a value based on this shortest propagation time. For example, the guard time interval can be set to a value that is a function of the propagation time plus some minor delay interval to reduce the possibility of collisions. At step 304, the uplink transmission slots in the TDD frame are arranged so that the mobile station with the shortest propagation time transmits in an uplink slot before the other mobile stations. The results of this new TDD frame structure, at step 305, are then transmitted to each mobile station so that each mobile station will know in which time slot it should commence its uplink transmission.

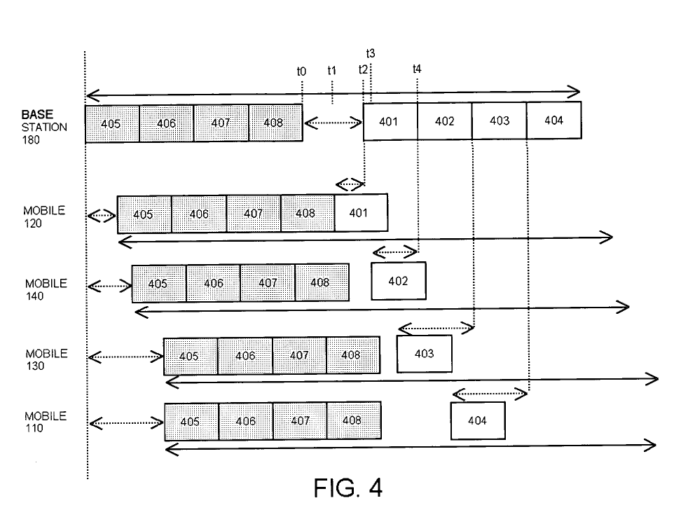

FIG. 4 is a diagram of a resulting time slot allocation, from the point of view of the base station 100 and the illustrative mobile stations 110, 120, 130, 140 depicted in FIG. 1. The TDD frame is advantageously divided into a downlink superframe, comprising downlink slots 405, 406, 407, 408 for different mobile stations, and an uplink superframe, comprising an uplink slots 401, 402, 403, 404 for different mobile stations. The TDD frame has a guard time interval 400 in between the superframes. Mobile station 120 is the closest to the base station 100. Accordingly, the guard time interval 400 is set to a value that approximates the round-trip propagation delay between mobile station 120 and the base station 100. The mobile station 120 is allocated an uplink time slot 401 that is at the beginning of the uplink superframe—and then followed by the uplink time slots 402, 403, 404 of the other mobile stations.

FIG. 4 shows how the time slot allocation, in accordance with a preferred embodiment of the present invention, advantageously complies with the design restrictions for time-division duplex. At time t0, the base station 100 completes transmission of the downlink superframe. The closest mobile station, mobile station 120, receives the end of the downlink superframe at time t1. After the final symbol of the last downlink packet reaches mobile station 120, the mobile station can immediately initiate uplink transmission at t1, regardless of whether the last downlink packet was intended for another mobile station. Because of causality, no collision will occur between the last downlink packet and the mobile station's first uplink packet of the time slot. The base station 100 receives the beginning of the first uplink transmission slot at time t2. The difference in time between t2 and t0 is the round trip propagation time to and from mobile station 120. With respect to the next uplink time slots, mobile station 140 waits until time t3 before commencing uplink transmission. The difference between time t3 and t4, the beginning of the next uplink time slot, is approximately the single-trip propagation time delay from the mobile station 140 back to the base station 100. The other mobile stations 130, 110 similarly delay their uplink transmissions so as to allow their transmissions to be received by the base station 100 in their corresponding uplink time slots 403, 404.

Thus, the invention results in a guard time interval that is only restricted by the distance of the mobile station closest to the base station, rather than the distance of the mobile station farthest from the base station (i.e., the cell radius) as in conventional TDD systems. With this approach, the cell size is no longer a limiting factor in TDD systems. With proper ordering of the collective uplink transmission, the proposed mechanism only requires a single guard time interval whose duration is determined by the mobile station closest to the base station in supporting communication between the base station and the given set of mobile stations and, hence, significantly improves the efficiency of TDD systems. Consider, for example, a typical TDD/TDMA system such as the digital European cordless telephone (DECT) system. A DECT frame consists of 24 time slots, the first 12 time slots for downlink transmission of 12 users (i.e., the downlink superframe) and the next 12 time slots for uplink transmission of 12 users (i.e., the uplink superframe). Each time slots has 480 bits, including 60 bits for guard time. It is assumed that 12 users are uniformly located within the cell; hence, the probability density functions (pdf's) of the distance from the base station to an arbitrary mobile station and the distance from the base station to the closest mobile station are, respectively, given by:
P_{any}(\tilde{r})=2\tilde{r},
Pₙₑₐᵣ(\tilde{r})=2K\tilde{r}(1−\tilde{r}²)^{K-1},
where \tilde{r} is the distance from the base station normalized by the cell radius; K is the number of mobile stations in the cell, which is 12 in the DECT system. η is herein defined as the TDD efficiency, which is the percentage of data transmission in each frame (i.e., the total frame interval minus the guard time interval, neglecting other overheads for simplicity). Therefore, in the DECT system, the TDD efficiencies of the above embodiment of the present invention would be:

$${η}_{1} = 1 - 0.2482 \times \frac{1}{24} \times \frac{60}{480} = 99.87 \%$$

where 0.2482 is the mean value of the normalized distance from the base station to the closest mobile station among 12 mobile stations and 1/24 is a factor due to the collective uplink transmission. The above efficiency computation is in contrast to the efficiency of conventional TDD and the above-mentioned enhanced prior art scheme:

$${η}_{2} = 1 - \frac{60}{480} = 87.50 \%$$

$${η}_{3} = 1 - \frac{2}{3} \times \frac{60}{480} = 91.67 \%$$

where ⅔ is the mean value of the normalized distance from the base station to an arbitrary mobile station. From this numerical example, the above embodiment can potentially provide 14.14% greater TDD efficiency than traditional TDD and 8.95% greater than the above-mentioned enhanced scheme. In another form, the TDD inefficiency is merely 0.13%, as opposed to 12.50% and 8.33% for the prior art mechanisms.

Note that any desired asymmetry between downlink and uplink traffic can be readily adjusted by varying the durations of the uplink/downlink superframes. The order of the downlink time slots can be arbitrary. The order of the remaining uplink Time slots after the time slot fo the closest mobile station can also be arbitrary, although it can be advantageous in certain circumstances to arrange the remaining time slots in an order of increasing progpagation delays, so as to permit outer lying mobile stations sufficient time to commence uplink transmissions. Alternatively, the different propagation delays of the different mobile stations can be split into zones of uplink time slots in the uplink superframe. Those mobile stations in the zone closest to the base station are placed in the first group of uplink time slots in the uplink superframe, those mobile stations in the zone next closest to the base station are allocated the next group of uplink time slots, etc.

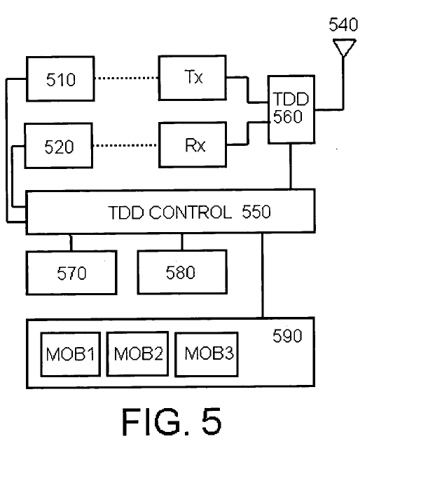

FIG. 5 is a simplified diagram of the components of a base station, in accordance with an embodiment of an aspect of the invention. The base station comprises transmitter 510 and receiver 520 circuitry which is connected to an antenna 540. The transmitter/receiver circuitry, for example and without limitation, can include a channel code and timeslot controller, as well as a corresponding modulation and spreading device with appropriate data interfaces. A switch or isolator 560 determines whether the base station is in uplink or downlink mode, under the control of a time-division duplex control module 550. The TDD control module 550 further comprises a propagation delay computation module 570 and a TDD frame layout module 580, responsible for rearranging the allocation of mobile station time slots based on information received from the propagation delay computation module 570. The propagation delay computation module 570, using some arbitrary protocol, is in communication with the different mobile stations and can exchange information with the mobile stations so as to estimate the propagation delay between the base station and the different mobile stations. The base station also comprises memory storage 590 for storing the new TDD frame layout received from the TDD frame layout module 580. The TDD control module 550 can then control the transmitter/receiver circuitry 510 520 in accordance with the TDD frame layout stored in the memory 590. Note that the functions of the different components of the base station can be implemented in hardware, firmware, or as software modules.

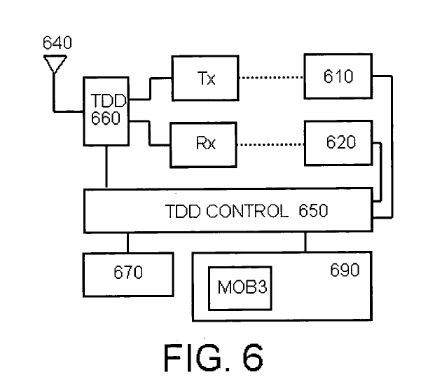

FIG. 6 is a simplified diagram of the components of a mobile station, in accordance with an embodiment of an aspect of the present invention. The mobile station can be any type of device that can be used in the mobile communication network, for example and without limitation, cellular or cordless telephones, personal digital assistants, notebook computers, or any other type of device (whether mobile or fixed, although preferably mobile) with an appropriate interface for the particular wireless link technology utilized. The device has transmitter circuitry 610 and receiver circuitry 620 connected to an antenna 540. A TDD control module 650 determines whether the mobile station is in transmit mode or receive mode through a switch or isolator 660. The TDD control module 650 further comprises a propagation delay computation module 570 and memory storage 690 for storing information on the TDD uplink frame structure received from the base station using some arbitrary protocol. Note that the mobile station can be responsible for computing when to commence its uplink transmission in the TDD frame, or, alternatively and preferably, the base station can compute this and download this information separately to each mobile station. The TDD control module 650, then, retrieves the information from the memory storage 690 and utilizes it to determine when the device should transmit and when it should receive. Note that the functions of the different components of the mobile station can be implemented in hardware, firmware, or as software modules.

It will be appreciated that those skilled in the art will be able to devise numerous arrangements and variations which, although not explicitly shown or described herein, embody the principles of the invention and are within their spirit and scope.

1. A method in a time division duplex mobile communication network comprising the steps of:
estimating a propagation delay between a base station and a plurality of mobile stations in the time division duplex mobile communication network;
arranging time slots in a frame in the time division duplex mobile communication network so that if the propagation delay between the base station and a first mobile station is less than the propagation delay between the base station and a second mobile station, the first mobile station is permitted to transmit in a time slot before the time slot of the second mobile station in the frame; and
where the frame has a guard time between transmissions from the base station to the mobile stations and transmissions received by the base station from the mobile stations, setting the guard time in the frame to a value based on the propagation delay between the base station and the first mobile station.

2. The method of claim 1 further comprising the step of transmitting messages to the mobile stations including information specifying the frame for each mobile station.

3. The method of claim 1 wherein the frame in the time division duplex communication system comprises an uplink superframe and a downlink superframe, the uplink superframe further comprising a plurality of uplink time slots for the plurality of mobile stations.

4. The method of claim 1 wherein the value of the guard time is based on a round trip propagation delay between the base station and the first mobile station.

5. The method of claim 1 wherein the value of the guard time is based on a two times a single trip propagation delay between the base station and the first mobile station.

6. The method of claim 1 wherein the first mobile station is closer to the base station than the other mobile stations.

7. A method of operating a base station in a time division duplex mobile communication network comprising the steps of:
transmitting in a downlink superframe, the downlink superframe further comprising a plurality of downlink time slots, each downlink time slot allocated to a mobile station in the time division duplex communication network;
waiting a guard time interval, the guard time interval at least equal to or greater than a round-trip propagation delay between the base station and a first mobile station; and
receiving uplink transmissions in an uplink superframe, the uplink superframe further comprising a plurality of uplink time slots, each uplink time slot allocated to a mobile station in the time division duplex communication network, the uplink time slots arranged so that a first uplink time slot at the beginning of the uplink superframe is allocated to the first mobile station, the first mobile station selected so that the round-trip propagation delay between the base station and the first mobile station is shorter than at least one other mobile station in the time division duplex communication network.

8. The method of claim 7 wherein the first mobile station has a shorter round-trip propagation delay to the base station than the other mobile stations in the time division duplex communication network.

9. A base station comprising:
a propagation delay computation module for estimating a propagation delay between the base station and a plurality of mobile stations;
a time division duplex frame layout module which can receive the propagation delays between the base station and the plurality of mobile stations and which arranges allocation of uplink time slots in a time division duplex frame so that a mobile station with a shorter propagation delay than at least one other mobile station is allocated an uplink time slot earlier than the other mobile stations and which sets a guard time interval in the time division duplex frame to a value based on the propagation delay between the base station and the mobile station; and
a time division duplex control module which is adapted to select between a transmit mode and a receive mode based on the time division duplex frame.

10. A mobile station with a time division duplex control module operative to select between an uplink transmit mode and a downlink receive mode based on a time division duplex frame specified by a base station, the time division duplex control module selecting the uplink transmit mode at the beginning of an uplink superframe in the time division duplex frame if an estimated propagation delay between the mobile station and the base station is less than at least one other mobile station in a time division duplex communication network.

11. The mobile station of claim 10 wherein the uplink transmit mode is selected at the beginning of the uplink superframe in the time division duplex frame if the mobile station is closer to the base station than the other mobile stations in the time division duplex communication network.
